(19) United States
(12) Patent Application Publication
(10) Pub. No.: US 2010/0214228 A1
(43) Pub. Date: Aug. 26, 2010

(54) DISPLAY DEVICE AND KEY ARRANGEMENT

(75) Inventors: Michael Sailer, Wolfskofen (DE); Michael Reich, Regensburg (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: OSRAM OPTO SEMICONDUCTORS GMBH, Regensburg (DE)

(21) Appl. No.: 12/676,386

(22) PCT Filed: Sep. 8, 2008
(86) PCT No.: PCT/DE2008/001512

§ 371 Date: May 10, 2010

(30) Foreign Application Priority Data
Sep. 11, 2007 (DE) 10 2007 043 190.4

(51) Int. Cl. G06F 3/02; F21V 8/00; F21V 13/12

(52) U.S. Cl. 345/169; 362/606; 362/19

(57) ABSTRACT

A display device includes a light source, an optical waveguide element with an emission area, optical waveguide element configured to conduct light from the light source onto an emission area, and a transflective element arranged on the emission area including a first layer with at least one first subregion and at least one second subregion, the first layer configured to transmit light from emission area in the first subregion and not to transmit in the second subregion, and a second layer arranged above the first layer in the emission direction of the light, the second layer configured to transmit at least a part of the light from light source.

### RELATED APPLICATIONS

This is a §371 of International Application No. PCT/DE2008/001512, with an international filing date of Sep. 8, 2008 (WO 2009/033468 A1, published Mar. 19, 2009), which is based on German Patent Application No. 10 2007 043 190.4, filed Sep. 11, 2007, the subject matter of which is incorporated by reference.

### TECHNICAL FIELD

This disclosure relates to a display device comprising a light source and an optical waveguide element. The disclosure further relates to a key arrangement for an electronic device.

### BACKGROUND

A number of display devices and key arrangements for electronic devices are known. Particularly in mobile telephones, it is common to assign different functions to one or more keys in different operating modes of the mobile telephone. To label their respective current function assignment, such multifunction keys are generally arranged underneath a display and the respective function is presented on the display.

Such an arrangement consisting of a multifunction key and a display leads to a loss of available display space on the display. Moreover, it can complicate the use of such an electronic device since such an arrangement is unclear in certain situations.

It could therefore be helpful to provide an improved display device and a key arrangement that allows a functional and simultaneously visually pleasant current function assignment of a key.

### SUMMARY

We provide a display device including a light source, an optical waveguide element with an emission area, optical waveguide element configured to conduct light from the light source onto an emission area, and a transflective element arranged on the emission area, including a first layer with at least one first subregion and at least one second subregion, the first layer configured to transmit light from emission area in the first subregion and not to transmit in the second subregion, and a second layer arranged above the first layer in the emission direction of the light, the second layer configured to transmit at least a part of the light from light source.

We also provide a key arrangement for an electronic device with a first and at least one second operating state including at least one key with a surface and the display device that is associated with the key, wherein the display device is configured not to display a symbol on a surface in the first operating state, and to display a symbol on the surface in the second operating state.

### BRIEF DESCRIPTION OF THE DRAWINGS

Our display devices and key arrangements will be described in detail below with reference to the drawings. The drawings show:

FIG. 1A is a schematic representation of a display device according to one configuration;

FIG. 1B is a schematic representation of a layer of the display device according to FIG. 1A;

FIG. 2A is a cross section through a display device in the off-state;

FIG. 2B is a plan view onto the display device according to FIG. 2A;

FIG. 3A is a cross section through a display device in the on-state;

FIG. 3B is a plan view onto the display device according to FIG. 3A; and

FIG. 4 is an electronic device with a key arrangement according to one configuration.

### DETAILED DESCRIPTION

We provide a display device comprising a light source, an optical waveguide element with an emission area, the optical waveguide element being configured to conduct light from the light source to the emission area, and a transflective element arranged on the emission area. The transflective element comprises a first layer with at least one first and at least one second subregion, the first layer being configured to transmit light from the emission area in the first subregion and not to transmit it in the second subregion, and with a second layer arranged above the first layer in the emission direction of the light, the second layer being configured to transmit at least a part of the light from the light source.

A space-saving display is implemented by using a display device comprising a light source, an optical waveguide element and a transflective element comprising a first and a second layer. The display device is, for example, suitable for installation in a key, so that it is possible to do without a display of a function assignment by means of a separately arranged display element.

According to one configuration, the second layer comprises a polarization foil and is configured to transmit light of a first polarization direction and not to transmit light of a second polarization direction. By using a polarization foil, incident ambient light is largely filtered out by the second layer, so that the display device is clearly readable even with incident ambient light.

According to another configuration, the second layer is arranged on a surface of the display device, the display device being configured to display a symbol on the surface with the light source turned on and not to display a symbol on the surface with the light source turned off. An operating state of an electronic device is clearly indicated by selectively displaying a symbol on the surface of the display device, for example, a keycap or a housing wall. Such a display device is also suitable for displaying company or brand names, which stand out visually in this way.

According to another configuration, an additional diffusion foil is arranged between the first layer and the second layer. Incident daylight is scattered by using an additional diffusion foil, so that the contrast ratio of the device is improved. In addition, a uniform illumination level of the display device is produced by the light source.

According to yet another configuration, the optical waveguide element and the first layer are divided into at least two parts, with a first and second part of the optical waveguide element or the first layer being separately illuminable, a first symbol being displayable by the display device if the first part is illuminated, and a second symbol if the second part is illuminated. Different symbols can be displayed by the display device by selective illumination of a first or second part.

We thus provide a key arrangement for an electronic device with a first and at least one second operating state, comprising at least one key with a surface and a display device according to one of the above configurations that is associated with the key. The display device is configured not to display a symbol on the surface in the first operating mode, and to display a symbol on the surface in the second operating mode. A current function of a key is emphasized by selective display of a symbol on a surface of the key.

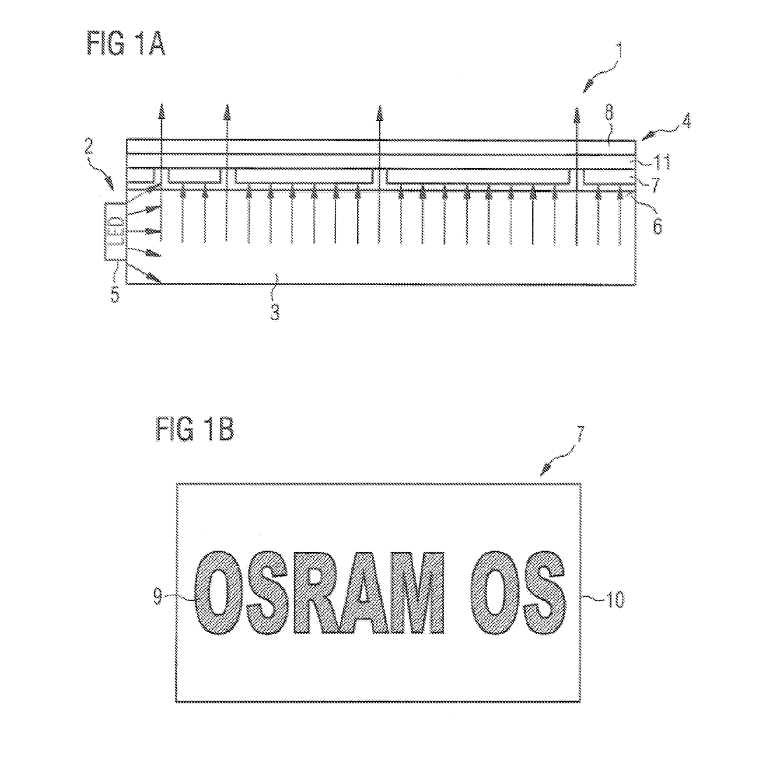

Turning now to the drawings, FIG. 1A shows a cross section through a display device 1. Display device 1 comprises a light source 2, an optical waveguide element 3 and a transflective element 4.

Light source 2 comprises a light-emitting diode (LED) 5. One or more other colored or white light sources can also be used in place of a light-emitting diode, however. Optical waveguide element 3 comprises, for example, an optical waveguide of polycarbonate (PC), polymethyl methacrylate (PMMA), silicone or a glass fiber mat. By using a light-emitting diode 5 and an optical waveguide element 3 made of a plastic material, they can be adapted particularly easily to the geometric requirements of display device 1. Alternatively, light-emitting diode 5 and optical waveguide element 3 can also be constructed as a single part to achieve a particularly compact construction.

Optical waveguide element 3 has an emission area 6, to which at least a part of the light from light source 2 is supplied. A total internal refection (TIR) of optical waveguide element 3 or light scattering of optical waveguide element 3 serves to supply the light.

In FIG. 1A, transflective element 4 comprises a first layer 7 and a second layer 8 that are arranged on emission area 6 of optical waveguide element 3. First layer 7 is a light-absorbing or light-reflecting foil with a structuring applied thereon.

FIG. 1B shows one configuration of a first layer 7 with a first subregion 9 and a second subregion 10. First subregion 9 is configured to transmit light emitted from emission area 6. Second subregion 10, on the other hand, is configured to reflect or absorb light from emission area 6. A non-transmissive black plastic foil, out of which symbols, letters or other display elements are cut can be used, for example.

Second layer 8 is at least partially transmissive for light from light source 2. For instance, second layer 8 can comprise a linearly or circularly polarizing filter foil. Alternatively, the use of a gray or colored filter foil is also possible.

In the configuration of display device 1 illustrated in FIG. 1A, an additional diffusion foil 11 is arranged between first layer 7 and second layer 8. The optional diffusion foil 11 scatters light incident from the surface of second layer 8, so that the structure of first layer 7 is visible when back-lit by light source 2. At the same time, it assures a uniform full illumination of the surface of display device 1 by light source 2.

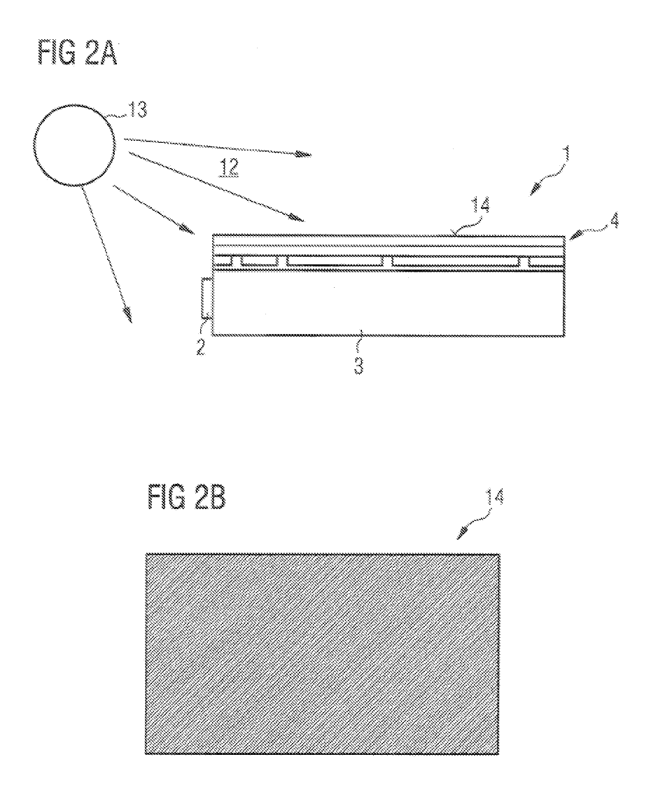

FIG. 2A shows a cross section through a display device 1. In the situation represented in FIG. 2A, ambient light 12 from an external light source 13 is incident on display device 1. The transflective element 4 of display device 1 absorbs a large part of the incident ambient light 12. In the example represented in FIG. 2A, light source 2 of display device 1 is deactivated. Therefore no symbol can be recognized on a surface 14 of display device 1 in the plan view of FIG. 2B. It appears as a uniformly colored surface. For example, a housing surface or a keycap can appear to be completely black.

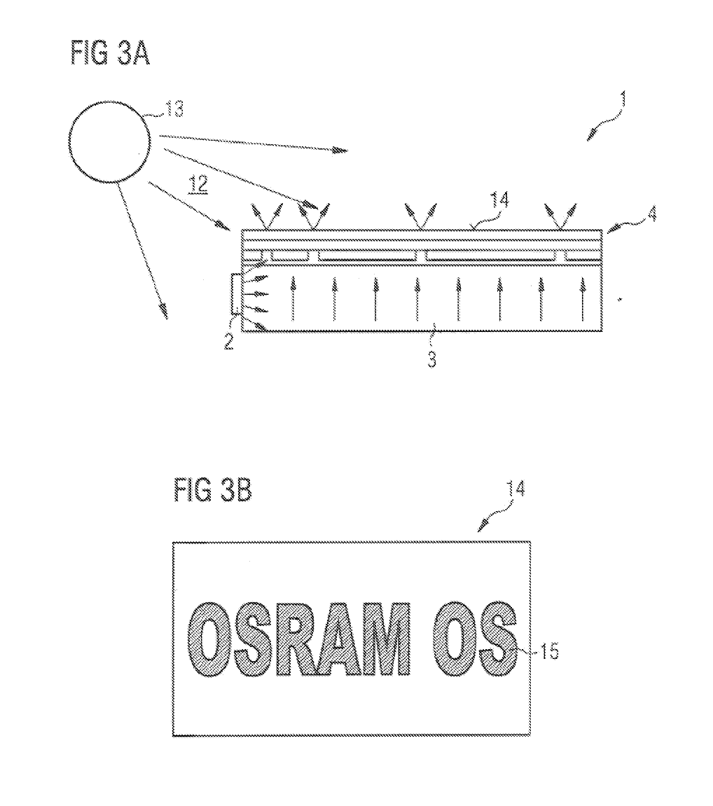

The same display device 1 as that shown in FIG. 2A is represented in FIG. 3A. In the state represented in FIG. 3A, however, light source 2 of display device 1 is turned on. The light emitted by light source 2 is supplied by optical waveguide element 3 to transflective element 4. Transflective element 4 transmits a part of the supplied light, so that a symbol 15 is represented on surface 14 of display device 1. The illustrated symbol 15 is recognizable in the plan view of FIG. 3B. This can be, for example, a company logo or a pictogram or lettering for a key function.

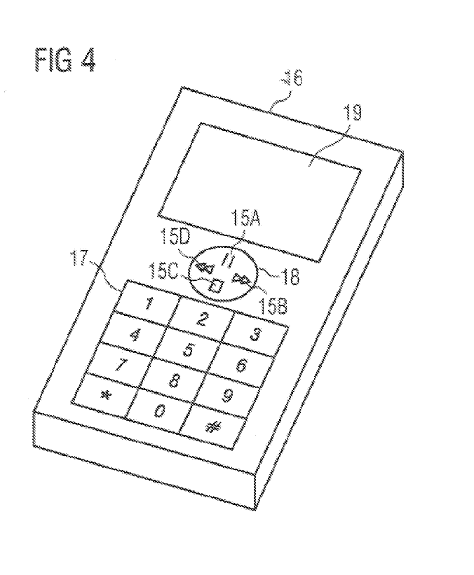

FIG. 4 shows a mobile electronic device 16. In that example, electronic device 16 is a mobile telephone. Electronic device 16 can be in a first and in a second operating state. For example, electronic device 16 serves for telephoning in a first operating state and for playing back media data in a second operating state.

Mobile electronic device 16 comprises a key field 17, a multifunction rocker switch 18 and a display 19. For example, key field 17 can be a numeric keypad for inputting numbers. Multifunction rocker switch 18 can be moved, for example, in four different directions, to the left, to the right, upwards and downwards. Display 19 is, for example, a liquid crystal display (LCD).

In the first operating state, for example, multifunction rocker switch 18 can be used to navigate through a menu structure shown on display 19. In the second operating state, an operating mode for playing back media data for example, multifunction rocker switch 18 does not serve to navigate through the menu structure but rather to execute predetermined commands. For instance, the four directions can serve as commands for moving forwards and backwards, stopping and pausing a piece of music being played back. In this second operating mode, four symbols 15A to 15D are displayed on multifunction rocker switch 18. If electronic device 16 is in the first operating mode, however, none of the symbols 15A to 15D are displayed, so that multifunction rocker switch 18 appears black, for example.

According to another example, not shown, electronic device 16 comprises a plurality of different operating states. For example, a mobile telephone can also have a digital camera function in addition to the already described media playback function. In the operating mode assigned to the digital camera function, one or more additional functions are assigned to one or a plurality of the keys in key field 17 and/or multifunction rocker switch 18. For example, a trigger function or an activation of a flash can be assigned to different positions of multifunction rocker switch 18.

In this configuration, individual areas of multifunction rocker switch 18 or key field 17 can be illuminated independently of one another. For instance, an optical waveguide element 3 or a first layer 7 can be subdivided into a first part and a second part that are illuminable by different light sources 2. In this manner, no symbols at all may be displayed on multifunction rocker switch 17 in the first operating mode of electronic device 16, while in a second or third operating mode of electronic device 16, different symbols 15 are displayed on multifunction rocker switch 18.

Depending on the housing or key geometry of electronic device 16, display elements 1 can also be arranged in an area other than a key, for example below, above or alongside a key.

Due to the situation-adapted display of symbols 15, the operation of electronic device 16 is considerably clearer in design, than if the respective function assignments are shown exclusively in display 19. In addition, display 19 is available without restriction for displaying additional information such as a picture currently being taken.

It may be pointed out that all of the above-described examples serve only to illustrate our display devices and key arrangements. It goes without saying that individual or all characteristics disclosed in the individual examples can be combined in a variety of ways with one another to achieve additional configurations.

1. A display device, comprising:
a light source,
an optical waveguide element with an emission area, optical waveguide element configured to conduct light from the light source onto n emission area, and
a transflective element arranged on the emission area, comprising a first layer with at least one first subregion and at least one second subregion, the first layer configured to transmit light from emission area in the first subregion and not to transmit in the second subregion, and a second layer arranged above the first layer in the emission direction of the light, the second layer configured to transmit at least a part of the light from light source.

2. The display device according to claim 1, wherein the second layer comprises a polarization foil and is configured to transmit light of a first polarization direction and not to transmit light of a second polarization direction.

3. The display device according to claim 1, wherein the second layer is arranged on a surface of the display device, the display device configured to display a symbol on a surface with the light source turned on and not to display a symbol on the surface with light source turned off.

4. The display device according to claim 1, wherein the first layer is arranged on an emission area of the optical waveguide element.

5. The display device according to claim 1, wherein an additional diffusion foil is arranged between the first layer and the second layer.

6. The display device according to claim 1, wherein the optical waveguide element and the first layer are divided into at least two parts, with a first and second part of the optical waveguide element or the first layer being separately illuminable, a first symbol being displayable by display device if the first part is illuminated, and a second symbol if the second part is illuminated.

7. The display device according to claim 1, wherein the light source comprises at least one light-emitting diode.

8. The display device according to claim 1, wherein the second layer comprises a polarization foil and is configured to transmit light of a first polarization direction and not to transmit light of a second polarization direction, and wherein an additional diffusion foil is arranged between the first layer and the second layer.

9. A key arrangement for an electronic device with a first and at least one second operating state comprising:
at least one key with a surface and the display device according to claim 1 that is associated with the key, wherein the display device is configured not to display a symbol on a surface in the first operating state, and to display a symbol on the surface in the second operating state.

10. The key arrangement according to claim 9, wherein the electronic device has a plurality of second operating states, and each of the second operating states is assigned a predetermined symbol that can be displayed by the display device on the surface of the key.

11. The display device according to claim 2, wherein the second layer is arranged on a surface of the display device, the display device configured to display a symbol on a surface with the light source turned on and not to display a symbol on the surface with light source turned off.

12. The display device according to claim 2, wherein the first layer is arranged on an emission area of the optical waveguide element.

13. The display device according to claim 3, wherein the first layer is arranged on an emission area of the optical waveguide element.

14. The display device according to claim 2, wherein an additional diffusion foil is arranged between the first layer and the second layer.

15. The display device according to claim 3, wherein an additional diffusion foil is arranged between the first layer and the second layer.

16. The display device according to claim 4, wherein an additional diffusion foil is arranged between the first layer and the second layer.

17. The display device according to claim 2, wherein the optical waveguide element and the first layer are divided into at least two parts, with a first and second part of the optical waveguide element or the first layer being separately illuminable, a first symbol being displayable by display device if the first part is illuminated, and a second symbol if the second part is illuminated.

18. The display device according to claim 3, wherein the optical waveguide element and the first layer are divided into at least two parts, with a first and second part of the optical waveguide element or the first layer being separately illuminable, a first symbol being displayable by display device if the first part is illuminated, and a second symbol if the second part is illuminated.

19. The display device according to claim 4, wherein the optical waveguide element and the first layer are divided into at least two parts, with a first and second part of the optical waveguide element or the first layer being separately illuminable, a first symbol being displayable by display device if the first part is illuminated, and a second symbol if the second part is illuminated.

20. The display device according to claim 5, wherein the optical waveguide element and the first layer are divided into at least two parts, with a first and second part of the optical waveguide element or the first layer being separately illuminable, a first symbol being displayable by display device if the first part is illuminated, and a second symbol if the second part is illuminated.
